(19) United States
(12) Patent Application Publication
(10) Pub. No.: US 2023/0393670 A1
(43) Pub. Date: Dec. 7, 2023

(54) LISMART COMPUTER POINTING DEVICE

(71) Applicant: Joy Wang, WOODINVILLE, WA (US)

(72) Inventor: Joy Wang, WOODINVILLE, WA (US)

(21) Appl. No.: 18/058,758

(22) Filed: Nov. 24, 2022

Related U.S. Application Data
(63) Continuation of application No. 17/832,607, filed on Jun. 4, 2022, now abandoned.

(51) Int. Cl. G06F 3/0354; G06F 3/0362; G06F 3/038; G06F 3/0485; G06V 40/13; G06F 3/03; G06F 3/04886

(52) U.S. Cl. CPC G06F 3/03543; G06F 3/0362; G06F 3/0383; G06F 3/0485; G06V 40/13; G06F 3/0325; G06F 3/04886

(57) ABSTRACT

A smart computer pointing device includes a body having a top surface and a bottom surface. The top surface includes one or more touch-sensitive areas configured to detect one or more touch inputs. The bottom surface is configured to be in touch with a flat surface. The smart computer pointing device further includes at least one of (1) a motion sensor disposed at the bottom surface configured to detect a motion of the body relative to the flat surface, (2) a wheel configured to rotate in response to a scrolling operation, (3) a display overlaid with at least one of the one or more touch-sensitive areas, (4) a speaker, (5) a microphone, or (6) a biometric sensor. The smart computer pointing device is configured to convert sensing data generated by the sensors into control signals and transmit the control signals to a computer system for controlling a graphical user interface.

### CROSS REFERENCE OF RELATED APPLICATION

This application is a continuation of U.S. patent application Ser. No. 17/832,607, filed Jun. 4, 2022, which is incorporated herein by reference in its entirety.

### BACKGROUND

A computer mouse is a hand-held pointing device that detects two-dimensional motion relative to a surface. This motion is typically translated into the motion of a pointer on a graphic user interface (GUI) of a computer system. In addition to moving a pointer, a computer mouse also has one or more mechanical buttons to allow interactions with other visual elements of the GUI, which in turn cause the computer system to perform different operations.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The smart computer pointing device described herein is configured to provide control signals to a computer system for controlling a graphical user interface (GUI) displayed on a display (also referred to as a first display). The smart computer pointing device includes a communication interface, a processor, and a hardware storage device. The communication interface (which may be a wired interface or a wireless interface) is configured to communicate with the computer system. The hardware storage device is configured to store executable instructions that are executable by the processor. The smart computer pointing device further includes a body. The body includes a top surface having one or more touch-sensitive areas configured to detect one or more touch inputs and a bottom surface configured to rest on a flat surface.

The smart computer pointing device further includes at least one of (1) a motion sensor disposed at a bottom surface of the body configured to detect a motion of the body relative to the flat surface, (2) a wheel configured to rotate in response to a scrolling input of a user, (3) a second display overlaid with at least one of the one or more touch-sensitive areas, (4) a speaker configured to play a sound, (5) a microphone configured to detect a sound, and/or (6) a biometric sensor configured to generate a biometric measurement of a user.

When the executable instructions are executed by the processor, the processor is configured to convert (1) the one or more touch inputs detected by the one or more touch-sensitive area, (2) the motion of the body detected by the motion sensor, (3) a rotation of the wheel, or (4) the biometric measurement generated by the biometric sensor to one or more control signals, and transmit the one or more control signals to the computer system via the communication interface to control the GUI.

In some embodiments, the processor is configured to divide the touch display into a plurality of areas, each of which forms a virtual button or a virtual wheel. In response to receiving a tap touch input in the area corresponding to the virtual button, the virtual button is configured to perform a click operation, and in response to receiving a wipe touch input in an area corresponding to the virtual wheel, the virtual wheel is configured to perform a scroll operation.

In some embodiments, the touch-sensitive area is overlaid with a display to form a touch display, and the touch display is configured to display the virtual button or the virtual wheel. In some embodiments, in response to receiving a tap touch input in the area corresponding to the virtual button, the touch display is configured to display a first sequence of moving images in an area of the virtual button to emulate a motion of clicking a mechanical button; and/or in response to receiving a swipe touch input in the area corresponding to the virtual wheel, the touch display is configured to display a sequence of moving images in an area of the virtual wheel to emulate a motion of scrolling a mechanical wheel.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not, therefore, to be considered to be limiting in scope, embodiments will be described and explained with additional specificity and details through the use of the accompanying drawings in which:

FIG. 1 illustrates an example of a system that implements the principles described herein;

FIG. 2 illustrates an example architecture of a smart computer pointing device that implements the principles described herein;

FIG. 3A illustrates an example embodiment of a smart computer pointing device including one or more touch-sensitive areas and one or more wheels;

FIGS. 3B-3L illustrate examples of touch inputs that can be received the one or more touch-sensitive areas;

FIG. 4 illustrates another example embodiment of a smart computer pointing device without a wheel;

FIG. 5 illustrates another example embodiment of a smart computer pointing device including four symmetric touch-sensitive areas;

FIG. 6 illustrates another example embodiment of a smart computer pointing device including three touch-sensitive areas;

FIG. 7 illustrates another example embodiment of a smart computer pointing device including three touch-sensitive areas;

FIGS. 8A and 8B illustrate another example embodiment of a smart computer pointing device including a touch-sensitive area and one or more wheels disposed on a side of the smart computer pointing device;

FIGS. 9A and 9B illustrate another example embodiment of a smart computer pointing device, including a touch-sensitive area on a top surface and a touch-sensitive area on a side of the smart computer pointing device;

FIGS. 9C and 9D illustrate that a user can use their thumb to swipe along a touch-sensitive area on a side of the smart computer pointing device to generate a control signal;

FIG. 10A-10C illustrate another embodiment of a smart computer pointing device that is a spherical dome-shaped;

FIG. 11 illustrates another example of a smart computer pointing device having a touch display configured to display a portion of a graphical user interface;

FIG. 12 illustrates another example of a smart computer pointing device including at least one fingerprint sensor configured to detect a fingerprint of a user;

FIG. 13 illustrates another example of a smart computer pointing device including a palmprint sensor configured to detect a palmprint of a user; and

FIG. 14 illustrates an example computer system in which the principles described herein may be employed.

### DETAILED DESCRIPTION

Existing computer pointing devices, such as mice and touchpads, are generally single-function devices that can only be used for computer pointing purposes. Further, a mouse and a touchpad function in different ways, and generally cannot be used interchangeably. For example, a mouse is configured to detect a motion of a user's hand relative to a surface, and a touchpad is configured to detect touch input generated by a user's finger(s).

The principles described herein integrate the functions of a mouse and a touchpad into a smart computer pointing device configured to perform not only the functions of both a mouse and a touchpad but also configured to authenticate a user, detect vital signs of a user, serve as a smart speaker or a smart display, and/or serve as home décor.

Further, existing computer pointing devices, such as mice or touchpads, generally have a fixed design (including its functional design and aesthetic design) that cannot be changed by users. For example, existing mice and/or touchpads often have one or more mechanical buttons and/or a mechanical wheel fixed at permanent locations. Further, each mouse or touchpad has a fixed look and feel. As such, mice or touchpads with different designs need to be manufactured separately, and when a user purchases a particular mouse or touchpad, they are stuck with the particular design that is implemented in the particular mouse or touchpad.

The principles described herein integrate the functions of mice and touchpads into a smart computer pointing device, allowing users to modify the functions and the look and feel of the computer pointing device based on their preferences.

The smart computer pointing device described herein includes one or more sensors configured to detect a multi-dimensional motion of a hand and/or various touch inputs of a user. The smart computer pointing device turns movements of the user's hand and/or touch inputs of finger(s) into a control signal, which in turn is used to move a pointer in a multi-dimensional graphical user interface (GUI) and/or manipulate the GUI in various manners.

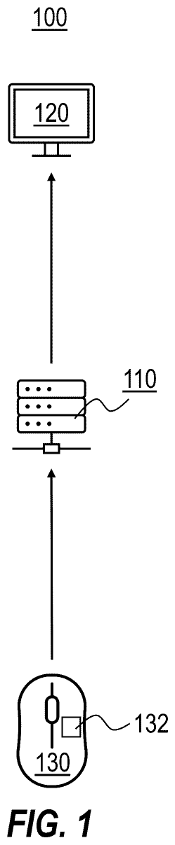

FIG. 1 illustrates an example of a system 100 that implements the principles described herein. The system 100 includes a computer system 110, a display device 120, and a smart computer pointing device 130. The display device 120 may be an internal or external display relative to the computer system 110. For example, when the computer system 110 is a traditional desktop computer, the display device 120 is an external display configured to be connected to the traditional desktop computer via a wired or wireless connection; alternatively, when the computer system 110 is a laptop, an all-in-one desktop computer, or a tablet, the display device 120 is an internal display integrated with the computer system 110.

In embodiments, the computer system 110 is configured to cause the display device 120 to display a GUI. The smart computer pointing device 130 includes one or more sensors configured to detect a multi-dimensional motion of a hand and/or a touch input of a finger of a user. The smart computer pointing device 130 is also configured to convert the detected multi-dimensional motion and/or touch input into a control signal and transmit the control signal to the computer system 110. Based on the received control signal, the computer system 110 then causes various operations to be performed in the GUI. For example, in some embodiments, the computer system 110 is configured to cause a pointer to be displayed in the GUI, and the smart computer pointing device 130 is configured to move the pointer, and cause the pointer to interact with other visual elements of the GUI, which in turn causes the computer system to perform different functions.

In some embodiments, the smart pointing device 130 includes a touch-sensitive surface that is configurable. For example, the touch-sensitive surface can be divided into a plurality of areas, each of which corresponds to a virtual button. In some embodiments, the touch-sensitive surface can be configured based on a plurality of predetermined configurations, such as (but not limited to) a two-button mouse configuration, a three-button mouse configuration, a mouse with a wheel configuration, a mouse without a wheel configuration, and/or a touchpad configuration. In some embodiments, the smart pointing device 130, and a user can use a switch to switch among the different configurations.

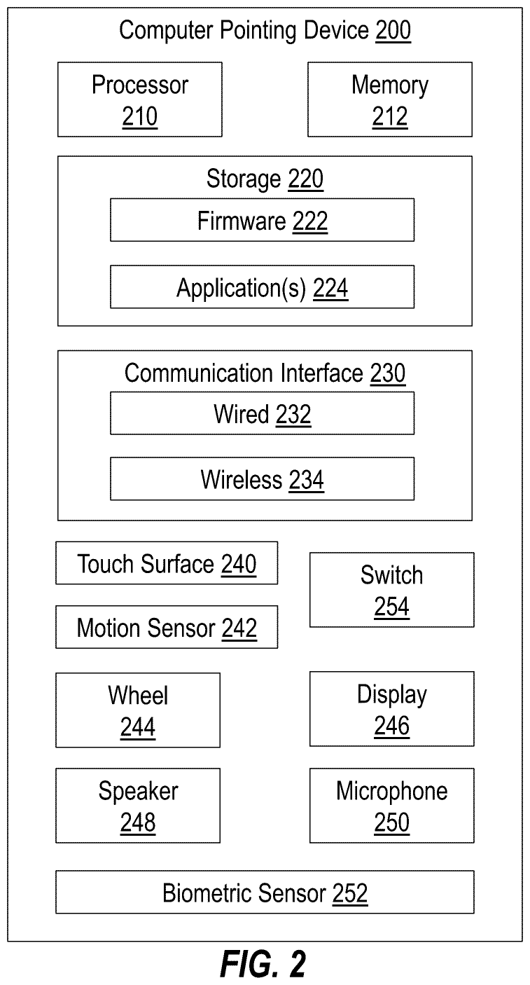

FIG. 2 illustrates an example architecture of a smart computer pointing device 200 (which corresponds to the smart computer pointing device 130 of FIG. 1). The smart computer pointing device 200 includes at least a processor 210, a hardware memory 212, a hardware storage 220, and a communication interface 230. The hardware storage 220 is configured to store computer-readable instructions, such as (but not limited to) firmware 222, and/or other applications 224. When the firmware is loaded in the memory 212 and executed by the processor 210, the smart computer pointing device 200 is configured to communicate with a computer system (e.g., computer system 110 of FIG. 1) over a communication interface 230. In some embodiments, the communication interface 230 includes a wired interface 232, configured to be connected to the computer system via a wired channel, such as a cable. Alternatively, or in addition, the communication interface 230 includes a wireless interface 234, configured to be connected to the computer system via a wireless channel, such as Bluetooth Low Energy (BLE) channel, a Wi-Fi channel, etc.

The smart computer pointing device 200 also includes a touch surface 240. The touch surface 240 is configured to detect one or more touch inputs from a finger of a user. The one or more touch inputs indicate different gestures that cause the GUI to perform one or more functions. In some embodiments, the one or more touch inputs include (but are not limited to) at least a single tap gesture, a double-tap gesture, a swipe gesture, a long-press gesture, a pinch gesture, a zoom gesture, a rotate gesture.

Additionally, the smart computer pointing device 200 further includes at least one of (1) a motion sensor 242, (2) a wheel 244, (3) a display 246, (4) a speaker 248, (5) a microphone 250, and/or (6) a biometric sensor 252.

The motion sensor 242 is configured to detect a multi-dimensional motion of itself relative to a surface, e.g., a desk surface. In some embodiments, the motion sensor 242 is an optical sensor disposed at a bottom side of the smart computer pointing device 200. The optical sensor includes a light emitter and a light sensor. The light emitter is configured to emit a light beam onto a surface that is in touch with the bottom side of the smart computer pointing device 200. The light beam is reflected by the surface to generate a reflection light beam, which is then received by the optical sensor. Based on the received reflection light beam, the optical sensor can then detect a movement of the smart computer pointing device relevant to the surface.

In some embodiments, the light sensor includes a camera configured to take a sequence of images of the surface. Based on the sequence of images, the optical sensor is configured to detect the movement of the smart computer pointing device 200 relevant to the surface. In some embodiments, the motion sensor 242 includes a ball and/or one or more rollers configured to roll against the surface, and the rotation of the ball is detected and measured to determine the motion of the smart computer pointing device 200.

The wheel 244 is configured to be rolled by a finger of a user, which in turn causes a GUI to scroll in a particular direction and/or causes a pointer on the GUI to move in a particular direction. In some embodiments, the smart computer pointing device 200 includes two wheels 244, namely a first wheel and a second wheel. The first wheel is configured to rotate in a first direction, causing the GUI or a portion of the GUI to scroll in a first direction (e.g., ±x-direction, or a horizontal direction), and the second wheel is configured to rotate in a second direction, causing the GUI or a portion of the GUI to scroll in a second direction (e.g., ±y-direction, or a vertical direction).

Display 246 is configured to display an image. In some embodiments, the image is a second GUI associated with setting up the smart computer pointing device 200. Note, the second GUI may or may not be associated with the GUI (also referred to as the first GUI) displayed on the display device 120 of the computer system 110. Alternatively, or in addition, the image is a reduced size or a portion of the first GUI. In some embodiments, the touch surface 240 and the display 246 are overlaid with each other, such that the display 246 functions as a touch display.

In some embodiments, the firmware 222 and/or application 224 are configured to divide a touch display into a plurality of virtual areas, each of which corresponds to a virtual button or a virtual wheel. In some embodiments, an area corresponding to a virtual button of the touch display is configured to display a button (emulating a mechanical button); and/or an area corresponding to a virtual wheel is configured to display a button (emulating a mechanical wheel). In some embodiments, when a user clicks the virtual button, a sequence of moving images can be displayed to emulate a motion of clicking a mechanical button, and/or when a virtual wheel is rotated, another sequence of moving images can be displayed to emulate a motion of scrolling a mechanical wheel.

In some embodiments, the touch-sensitive surface can be configured based on a plurality of predetermined configurations, such as (but not limited to) a two-button mouse configuration, a three-button mouse configuration, a mouse with a wheel configuration, a mouse without a wheel configuration, and/or a touchpad configuration. In some embodiments, the smart pointing device 254, and a user can use a switch to switch among the different configurations.

Speaker 248 is configured to play a sound. In some embodiments, the sound played by speaker 248 is associated with the computer system 110 and/or the GUI displayed on display device 120. Alternatively, or in addition, the sound played by speaker 248 is associated with the functions of the smart computer pointing device 200, such as set up instructions for setting up the smart computer pointing device 200, or a clicking sound emulating a clicking of a mouse. In some embodiments, the smart computer pointing device also includes a speaker configured to mimic the sound of a mechanical mouse. For example, when a virtual button is clicked, the speaker is configured to make a mouse clicking sound, and when a virtual wheel is rotated, the speaker is configured to make a mechanical wheel rotating sound. In some embodiments, when the smart computer pointing device is idled and/or being charged, a screen saver is displayed on the touch screen of the device, such that the smart computer pointing device can also function as home decor. Users can set different screen savers based on their personal preferences.

The microphone 250 is configured to receive a sound signal, such as a voice command, or perform a voice recording function. In some embodiments, the processor 210, the microphone 250, the speaker 248, and/or the display 246 are configured to function as a smart speaker and/or a smart display, such that the smart computer pointing device 200 is configured to receive voice commands from a user and respond to the voice command with the speaker or the display.

In some embodiments, the smart computer pointing device 200 also includes a biometric sensor 252 configured to generate a biometric measurement of a user. In some embodiments, the biometric sensor 252 includes (but is not limited to) a fingerprint sensor or a palmprint sensor configured to detect a unique biometric character of the user. Alternatively, or in addition, the biometric sensor 252 includes (but is not limited to) a heart rate sensor, an oxygen-level sensor, a respiration rate sensor, a thermometer, and/or a blood pressure sensor configured to measure a vital sign of the user.

In some embodiments, the measurements of vital signs of the user are displayed on display 246 of the smart computer pointing device 200, and/or a display device 120 of the computer system 110. In some embodiments, the firmware 222 and/or applications 224 are configured to aggregate the measurements of the vital signs of the user to establish a baseline of the user using machine learning techniques. The established baseline can then be used to detect anomalies. The detected anomalies can be translated into a stress level and/or a health issue. In some embodiments, in response to detecting an anomaly, the smart computer pointing device 200 is configured to generate an alert, alerting the user of the detected anomaly, such as a high-stress level, and/or a health issue. In some embodiments, the smart computer pointing device 200 is also configured to generate a reminder, reminding the user to walk around, after the user has been using the smart computer pointing device 200 continuously for a predetermined threshold of time.

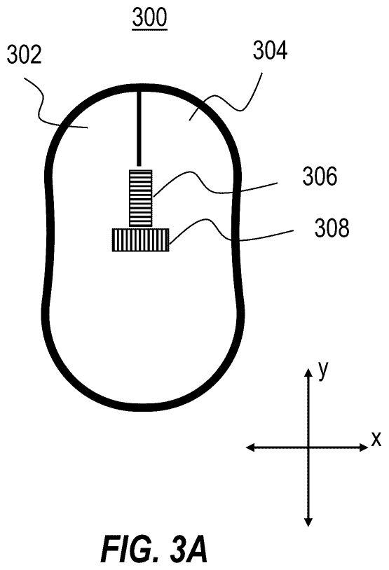

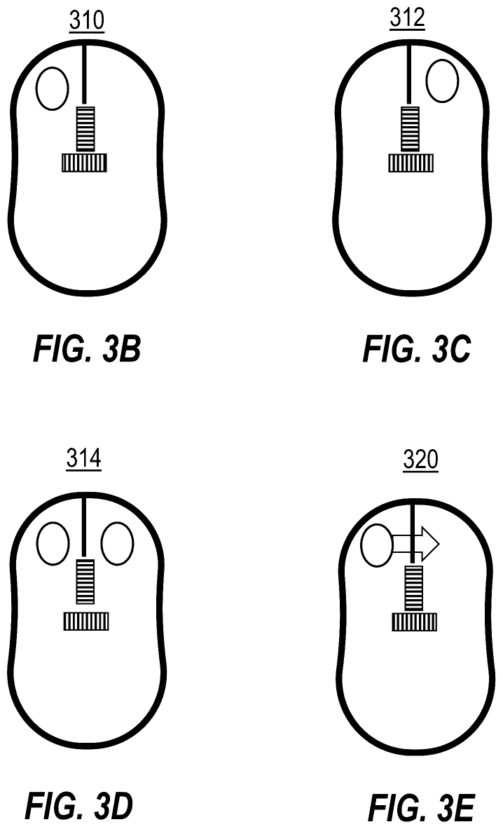

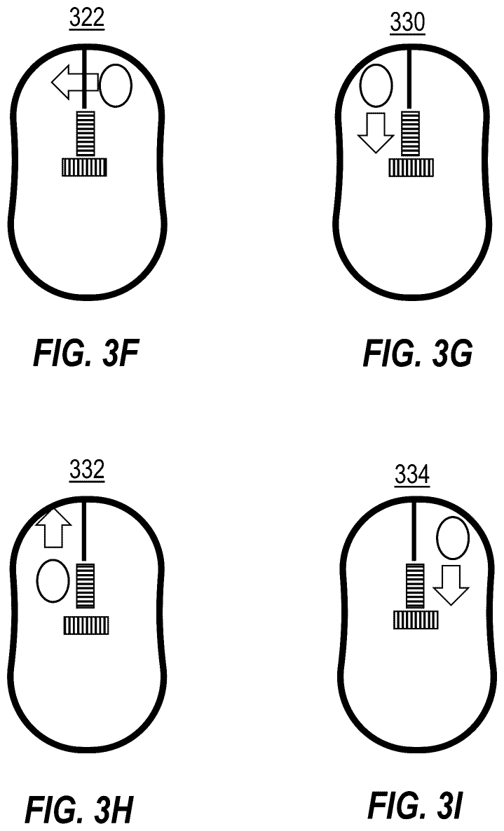

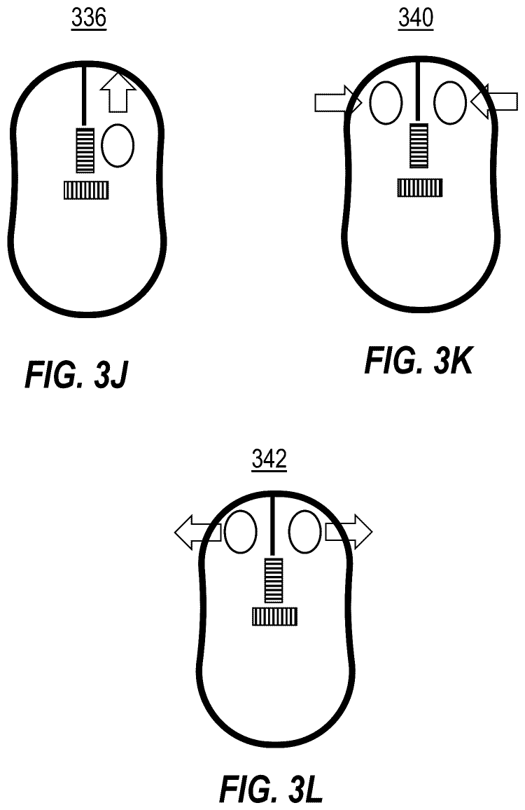

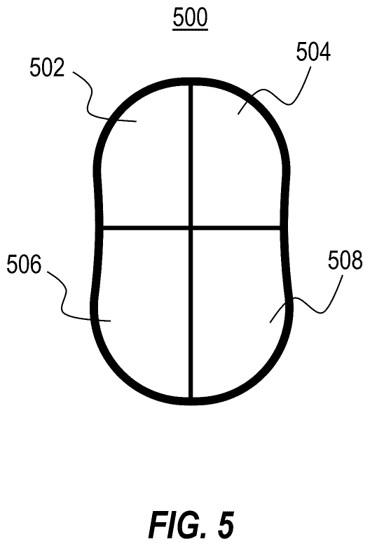

FIGS. 3A-13 further illustrate different example embodiments of smart computer pointing devices that correspond to the smart computer pointing device 200 of FIG. 2.

FIG. 3A illustrates an example embodiment of a smart computer pointing device 300. The smart computer pointing device 300 includes a body having a top surface and a bottom surface. The bottom surface is configured to rest on a flat surface. FIG. 3A illustrates a top view of the smart computer pointing device 300, showing the top surface thereof. As illustrated, the top surface of the smart computer pointing device 300 includes a first touch-sensitive area 302, a second touch-sensitive area 304, a first wheel 306, and a second wheel 308. Each of the first touch-sensitive area 302 and the second touch-sensitive area 304 is configured to receive one or more touch inputs from a finger of a user. The first wheel 306 is configured to rotate in a first direction (e.g., ±y directions), and the second wheel 308 is configured to rotate in a second direction (e.g., ±x directions).

FIGS. 3B-3L further illustrate examples of touch inputs that can be received by the first touch-sensitive area 302 and the second touch-sensitive area 304. FIG. 3B illustrates a touch input 310 received by the first touch-sensitive area 302, and FIG. 3C illustrates a touch input 320 received by the second touch-sensitive area 304. Each of the touch inputs 310 and 312 may be (but are not limited to) a single tap input, a double tap input, and/or a long press input. FIG. 3D illustrates a touch input 314, including simultaneously touching the first touch-sensitive area 302 and the second touch-sensitive area 304. FIG. 3E illustrates a touch input 320 indicating a swipe right gesture, during which the touch input starts from the first touch-sensitive area 302 and ends in the second touch-sensitive area 304. FIG. 3F illustrates a touch input 322 indicating a swipe left gesture, during which a finger starts from the second touch-sensitive area 304 and ends in the first touch-sensitive area 302.

FIG. 3G illustrates a touch input 330 indicating a swipe down gesture in the first touch-sensitive area 302, during which a finger starts from an upper area of the first touch-sensitive area 302 and ends in a lower area of the first touch-sensitive area 302. FIG. 3H illustrates a touch input 332 indicating a swipe-up gesture in the first touch-sensitive area 302, during which a finger starts from a lower area of the first touch-sensitive area 302 and ends in an upper area of the first touch-sensitive area 302. FIGS. 31 and 3J illustrate touch inputs 334 and 336, indicating a swipe down gesture and a swipe up gesture in the second touch-sensitive area 304. The touch inputs 334, 336 are similar to the touch inputs 330, 332, except that the touch inputs 334, 336 are performed on the second touch-sensitive area 304.

FIG. 3K illustrates a touch input 340 indicating a pinch gesture, during which a first finger and a second finger simultaneously start from an outer side of the first touch-sensitive area 302 and the second touch-sensitive area 304 respectively and end at an inner side of the first touch-sensitive area 302 and the second touch-sensitive area 304. FIG. 3L illustrates a touch input 342 indicating a zoom gesture, during which a first finger and a second finger simultaneously start from an inner side of the first touch-sensitive area 302 and the second touch-sensitive area 304 respectively and end at an outer side of the first touch-sensitive area 302 and the second touch-sensitive area 304.

Each of these touch inputs 310-342 or gestures can be configured to correspond to an operation on a GUI. For example, a single tap in the first touch-sensitive area 302 may correspond to a traditional single left click, a single tap in the second touch-sensitive area 304 may correspond to a traditional single right-click.

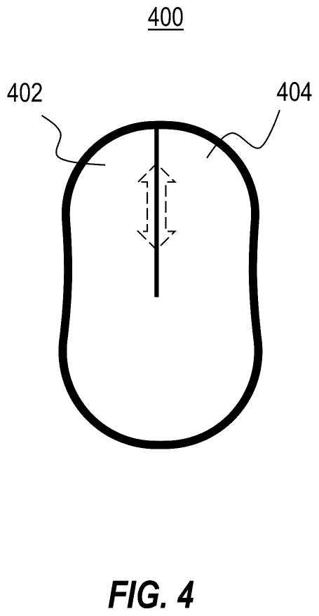

Even though the example of a smart computer pointing device 300 of FIG. 3A includes two wheels 306 and 308, the wheels 306 and 308 are not required. FIG. 4 illustrates another example embodiment of a smart computer pointing device 400 without a wheel. The smart computer pointing device 400 also includes a first touch-sensitive area 402 and a second touch-sensitive area 404. In some embodiments, a user can drag their finger along the boundary between the first touch-sensitive area 402 and the second touch-sensitive area 404 to cause a GUI to scroll vertically, similar to the function of roller the first wheel 306 of FIG. 3A.

In some embodiments, the smart computer pointing device has a symmetric shape, divided into four equal areas. Each of the four equal areas is a touch-sensitive area, and the user can use the device in one of the four different orientations. Figure illustrates an example of a smart computer pointing device 500, including four symmetric touch-sensitive areas 502, 504, 506, and 508. In some embodiments, the touch-sensitive areas 502, 504, 506, and 508 are configured to detect a particular touch gesture to activate those particular touch-sensitive areas. In some embodiments, the touch-sensitive areas 502, 504, 506, 508 are configured to sense a palm of a user, and activate one or two touch-sensitive areas that are on an opposite side of the sensed palm. For example, when the touch-sensitive areas 506 and 508 determine that a palm of a user is resting thereon, the touch-sensitive areas 502 and 504 are activated to receive finger-triggered touch inputs. As another example, when touch-sensitive areas 502 and 506 determine that a palm of a user is resting thereon, the touch-sensitive areas 504 and 508 are activated to receive finger-triggered touch inputs.

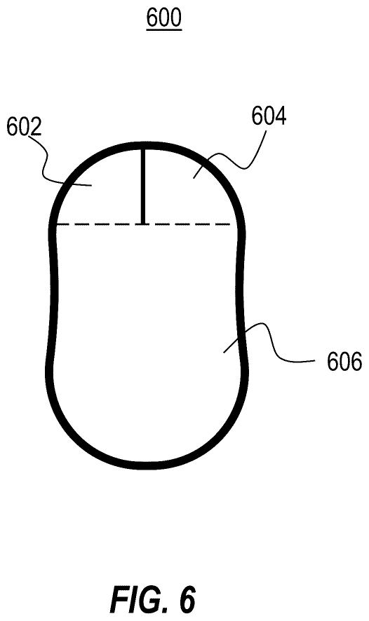

In some embodiments, the smart computer pointing device includes three touch-sensitive areas. FIG. 6 illustrates an example of a smart computer pointing device 600, including three touch-sensitive areas, namely a first touch-sensitive area 602, a second touch-sensitive area 604, and a third touch-sensitive area 606. The first touch-sensitive area 602 is positioned at an upper left corner, the second touch-sensitive area 604 is positioned at an upper right corner, and the third touch-sensitive area 606 is positioned at a lower area below both the first touch-sensitive area 602 and the second touch( )sensitive area 604.

In some embodiments, each of the first touch-sensitive area 602 and the second touch-sensitive area 604 are configured to receive a first set of touch inputs, and the third touch-sensitive area 606 is configured to receive a second set of touch inputs. In some embodiments, each touch input in the first set of touch inputs generally requires a single finger, such as (but not limited to) single tap, double tap, triple tap, long press, etc; and each touch input in the second set of touch inputs generally requires more than one finger, such as (but not limited to swipe left, swipe right, swipe up, swipe down, pinch, zoom, etc.), although two fingers can simultaneously touch both the first touch-sensitive area 602 and the second touch-sensitive area 604.

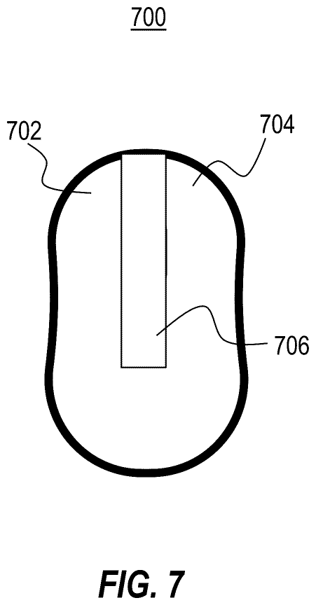

FIG. 7 illustrates another example of a smart computer pointing device 700, including three touch-sensitive areas, namely a first touch-sensitive area 702, a second touch-sensitive area 704, and a third touch-sensitive area 706. The first touch-sensitive area 702 is positioned at a left side, the second touch-sensitive area 704 is positioned at a right side, and the third touch-sensitive area 706 is positioned at a center portion. In some embodiments, the third touch-sensitive area 706 is an elongate strip configured to allow a user to swipe therealong, causing a GUI to scroll vertically. Each of the first touch-sensitive areas 702, 704, 706 is configured to receive different touch inputs as those described with respect to FIGS. 3A-3L.

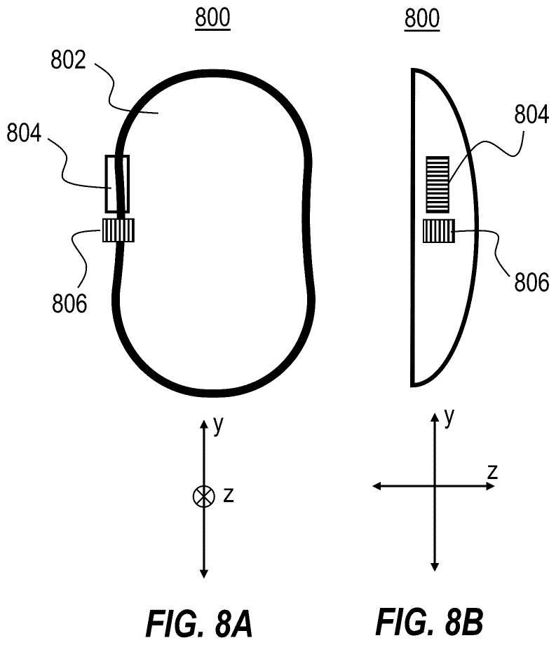

FIGS. 8A and 8B illustrate another example of a smart computer pointing device 800, including a touch-sensitive area 802, a first wheel 804, and a second wheel 806. The first wheel 804 and the second wheel 806 are positioned on a side of the computing pointing device 800. The first wheel 804 is configured to rotate in a first direction (e.g., +-y-direction), and the second wheel 806 is configured to rotate in a second direction (e.g., +-z-direction). A user can use their thumb to rotate the first wheel 804 or the second wheel 806 to cause a GUI to scroll in a particular direction, such as vertically or horizontally.

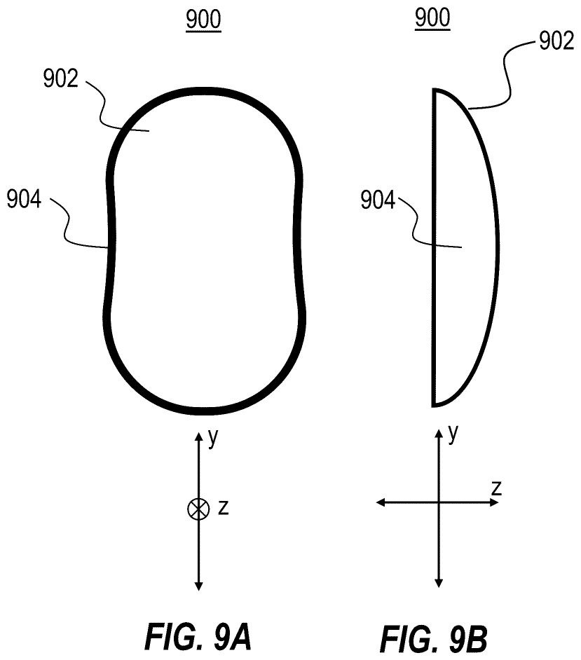

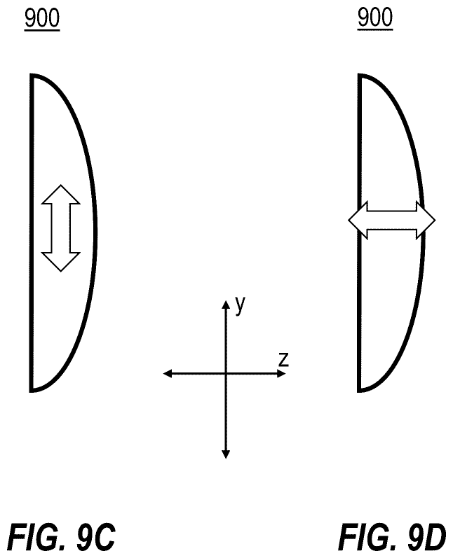

FIGS. 9A and 9B illustrate another example of a smart computer pointing device 900, including a first touch-sensitive area 902 and a second touch-sensitive area 904. The first touch-sensitive area 902 is positioned on a top surface of the smart computer pointing device. The second touch-sensitive area 904 is positioned on a side of the smart computer pointing device. Referring to FIGS. 9C and 9D, a user can use their thumb to swipe along the second touch-sensitive area 904 in a first direction (e.g., +-y-direction) and/or a second direction (e.g., +-z-direction). In some embodiments, swiping in the first direction in the second touch-sensitive area 904 is configured to cause a GUI to scroll in a first direction (e.g., vertically), and/or swiping in the second direction in the second touch-sensitive area 904 is configured to cause the GUI to scroll in a second direction (e.g., horizontally).

In some embodiments, the multiple touch-sensitive areas shown in FIGS. 3A-9D are formed by multiple different touch-sensitive devices. Alternatively, in some embodiments, the multiple touch-sensitive areas are formed by virtually dividing a single touch-sensitive device into multiple areas via software. In some embodiments, the virtually divided multiple touch-sensitive areas are virtual buttons and/or virtual wheels configured to operate in a manner that is similar to a mechanical button or a mechanical wheel of a traditional mouse. In some embodiments, in response to receiving a tap touch input from a user, the virtual button is configured to perform a click operation; and/or in response to receiving a swipe touch input, the virtual wheel is configured to perform a scroll operation.

In some embodiments, these virtual buttons and/or virtual wheels are programmable based on users' preferences. For example, some users prefer to have a wheel in the middle of a top surface, and some users prefer to have a wheel on a side surface, some users are right-handed, some users are left-handed, some users have longer fingers or larger hands, and some users have shorter fingers or smaller hands. The smart computer pointing device described herein allows different users to customize different virtual components based on their preferences.

In some embodiments, at least one touch-sensitive area is overlaid with a display, forming a touch display. In some embodiments, the virtual components (such as the virtual buttons and/or virtual wheels) are displayed on the touch display, such that the user can visually see them. When a user modifies the configurations of the different virtual components, the updated virtual components are displayed on the touch display. In some embodiments, a user can customize the look and feel of the different virtual components, such as changing the colors, patterns, and/or setting up dynamic themes of the different virtual components. In some embodiments, when a user clicks the virtual button, a sequence of moving images can be displayed to emulate a motion of clicking a mechanical button; and/or when a virtual wheel is rotated, another sequence of moving images can be displayed to emulate a motion of scrolling a mechanical wheel.

In some embodiments, the smart computer pointing device also includes a speaker configured to mimic the sound of a mechanical mouse. For example, when a virtual button is clicked, the speaker is configured to make a mouse clicking sound, and when a virtual wheel is rotated, the speaker is configured to make a mechanical wheel rotating sound. In some embodiments, when the smart computer pointing device is idled and/or being charged, a screen saver is displayed on the touch screen of the smart computer pointing device, such that the smart computer pointing device can also function as home decor. Users can set different screen savers based on their personal preferences.

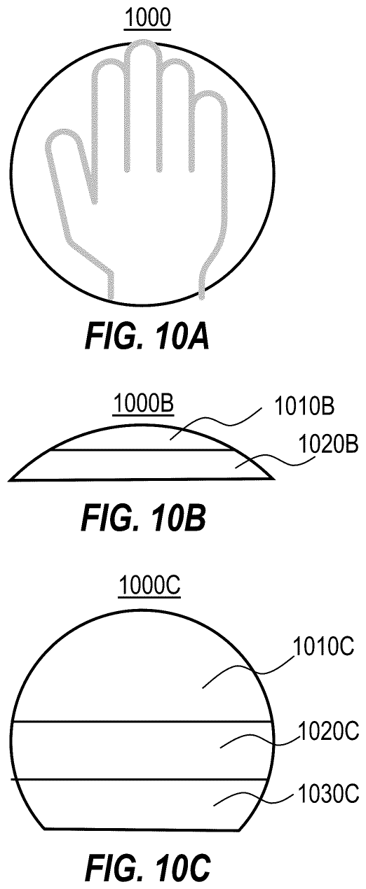

Even though the embodiments illustrated in FIGS. 3A-9D have a shape that generally corresponds to a traditional mouse, the smart computer pointing device described herein is not limited to such a shape. FIGS. 10A-10C illustrate another embodiment of a smart computer pointing device 1000 that is a spherical dome-shaped. FIG. 10A illustrates a top view of the smart computer pointing device 1000. In some embodiments, the smart computer pointing device 1000 is a spherical dome that is less than a half of a sphere. FIG. 10B illustrates a side view of such a smart computer pointing device 1000B. In some embodiments, the smart computer pointing device 1000 is a spherical dome that is greater than a half of a sphere. FIG. 10C illustrates a side view of such a smart computer pointing device 1000C.

In some embodiments, the spherical dome-shaped smart computer pointing device 1000 has a single touch-sensitive area. In some embodiments, the spherical dome-shaped smart computer pointing device 1000 is divided into a plurality of touch-sensitive areas that are symmetric to a diameter of the dome. For example, in FIG. 10B, the spherical dome-shaped smart computer pointing device 1000B is divided into two touch-sensitive areas 1010B and 1020B; and in FIG. 10C, the spherical dome-shaped smart computer pointing device 1000C is divided into three touch-sensitive areas 1010C, 1020C, and 1030C. Notably, each of the touch-sensitive areas 1010B and 1010C is dome-shaped, and each of the touch-sensitive areas 1020B, 1020C, 1030C is spherical ring-shaped.

Similarly, in some embodiments these different touch-sensitive areas 1010B, 1020B, 1010C, 1020C, 1030C are separate touch-sensitive devices. In some embodiments, the whole dome-shaped surface is a single piece of touch-sensitive device, and the single piece of touch-sensitive device is virtually divided into multiple areas. In some embodiments, the touch-sensitive device includes a dome-shaped display to form a dome-shaped touch screen. Again, different visual effects can be generated on the dome-shaped display. In some embodiments, when the dome-shaped smart computer pointing device is idled and/or being charged, a screen saver is displayed. Since the screen is dome-shaped (similar to a snow globe, a fish tank, or any other three-dimensional home decor), some screen savers can be designed to simulate these types of decor.

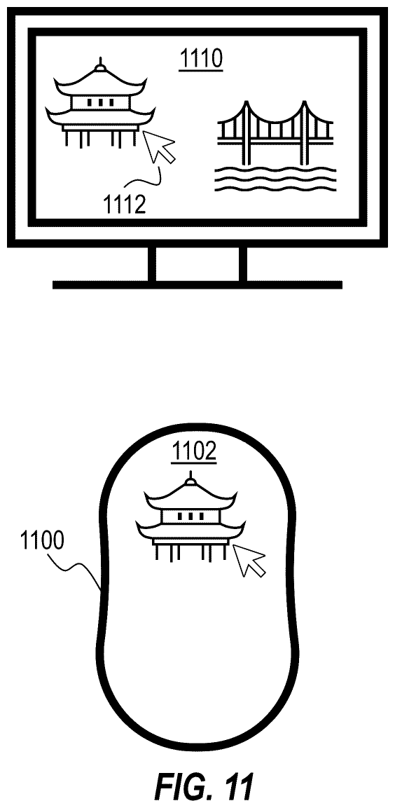

In some embodiments, the single touch-sensitive area (e.g., touch-sensitive area 802) or the largest touch-sensitive area (e.g., touch-sensitive area 902) is configured to function as a touchpad or a touch display. FIG. 11 illustrates an example of a smart computer pointing device 1100 having a touch display 1102 configured to display a portion of the GUI 1110. In some embodiments, the portion of the GUI 1110 displayed on the touch display 1102 of the smart computer pointing device 1100 is the portion next to a pointer 1112.

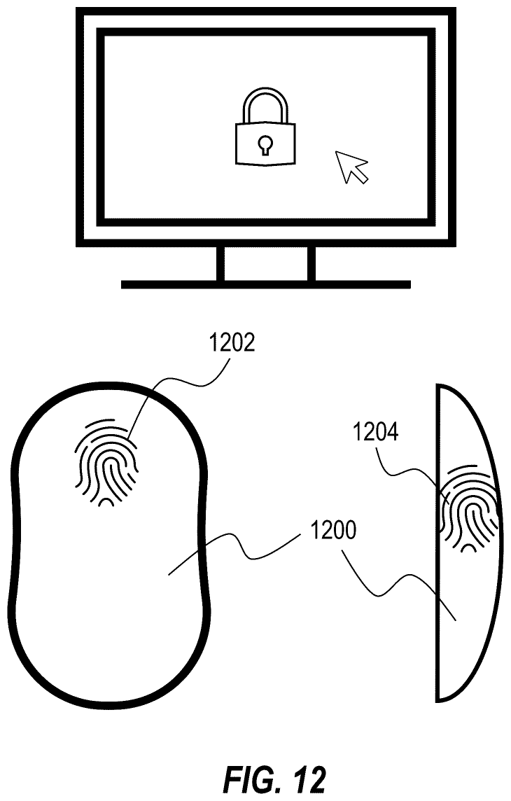

In some embodiments, the smart computer pointing device described herein also includes one or more fingerprint sensors configured to detect a fingerprint of a user. FIG. 12 illustrates an example of a smart computer pointing device 1200, including at least one fingerprint sensor. In some embodiments, the fingerprint sensor (e.g., fingerprint sensor 1202) is embedded under a top surface of the smart computer pointing device. Alternatively, or in addition, the fingerprint sensor (e.g., fingerprint sensor 1204) is embedded under a side surface of the smart computer pointing device configured to detect a thumbprint of a user. In some embodiments, the fingerprint sensor 1202, 1204 is used by an operating system or an application of the computer system 110 as a security feature. For example, a user can use the fingerprint sensor 1202, 1204 to authenticate themselves. In some embodiments, the fingerprint sensor 1202 is configured to detect a fingerprint of a user at a predetermined frequency, such as every minute, every 30 seconds, etc. When the fingerprint sensor 1202, 1204 determines that a registered user has been replaced by a different user, the fingerprint sensor 1202 causes a user session of the computer system or an application to be terminated automatically.

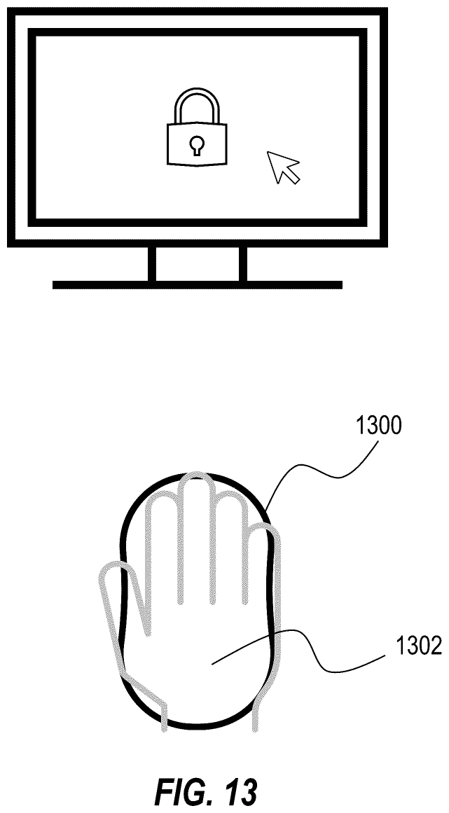

In some embodiments, the smart computer pointing device described herein also includes a palmprint sensor. FIG. 13 illustrates an example of a smart computer pointing device having a palmprint sensor 1302 configured to detect a palmprint of a user. Similar to the fingerprint sensor 1202, 1204 of FIG. 12, the palmprint sensor 1302 can also be used by an operating system or an application of the computer system. In some embodiments, the palmprint sensor 1302 is configured to detect a palmprint of a user at a predetermined frequency, such as every 5 minutes, every minute, every 30 seconds, etc. when the palmprint sensor determines that a registered user has been replaced by a different user, the palmprint sensor 1302 causes a user session of the computer system or an application to be terminated automatically.

In some embodiments, an LED or an array of LEDs are placed under each of the touch-sensitive areas. The LED or an array of LEDs are configured to light up when a touch input is received. In some embodiments, the LEDs are configured to follow a touch input. For example, when a swipe gesture is received, a subset of LEDs are light up sequentially following the swipe gesture.

In some embodiments, any one of the smart computer pointing devices 300, 400, 500, 600, 700, 800, 900, 1000, 1100, 1200, and/or 1300 also includes a motion sensor (e.g., motion sensor 242 of FIG. 2) configured to detect a motion of itself relative to a surface (e.g., a table surface) on which the smart computer pointing device is placed. In some embodiments, the motion sensor is an optical sensor disposed at a bottom side of the smart computer pointing device. The optical sensor includes a light emitter and a light sensor. The light emitter is configured to emit a light beam onto a surface that is in touch with the bottom side of the smart computer pointing device. The light beam is reflected by the surface to generate a reflection light beam, which is then received by the optical sensor. Based on the received reflection light beam, the optical sensor can then detect a movement of the smart computer pointing device relevant to the surface. In some embodiments, the light sensor includes a camera configured to take a sequence of images of the surface. Based on the sequence of images, the optical sensor is configured to detect the movement of the smart computer pointing device relevant to the surface. In some embodiments, the motion sensor includes a ball and/or one or more rollers configured to roll against the surface, and the rotation of the ball is detected and measured to determine the motion of the smart computer pointing device.

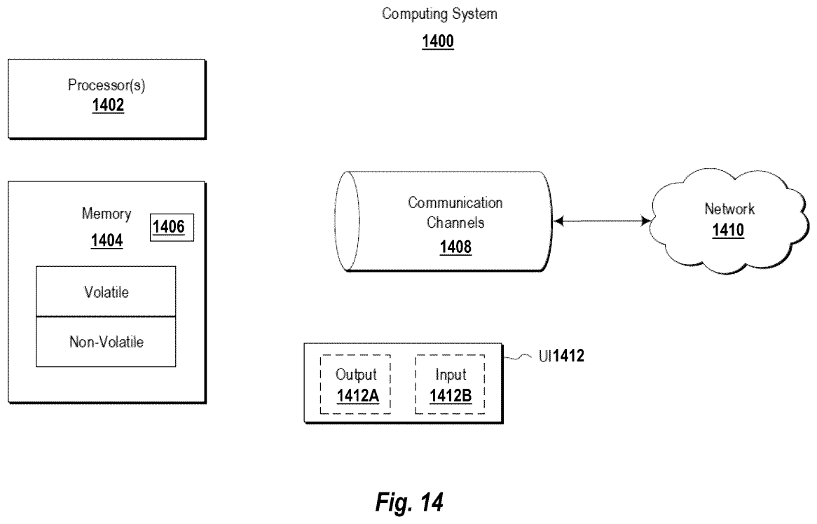

Finally, because the principles described herein may be performed in the context of a computer system, some introductory discussion of a computer system will be described with respect to FIG. 14.

Computer systems are now increasingly taking a wide variety of forms. Computer systems may, for example, be hand-held devices, appliances, laptop computers, desktop computers, mainframes, distributed computer systems, data centers, or even devices that have not conventionally been considered a computer system, such as wearables (e.g., glasses). For example, the smart computer pointing device described herein is a computer system, and the smart computer pointing device is configured to communicate with another computer system. In this description and in the claims, the term “computer system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computer system. A computer system may be distributed over a network environment and may include multiple constituent computer systems.

As illustrated in FIG. 14, in its most basic configuration, a computer system 1400 typically includes at least one hardware processing unit 1402 and memory 1404. The processing unit 1402 may include a general-purpose processor and may also include a field-programmable gate array (FPGA), an application-specific integrated circuit (ASIC), or any other specialized circuit. The memory 1404 may be physical system memory, which may be volatile, non-volatile, or some combination of the two. The term “memory” may also be used herein to refer to non-volatile mass storage such as physical storage media. If the computer system is distributed, the processing, memory and/or storage capability may be distributed as well.

The computer system 1400 also has thereon multiple structures often referred to as an “executable component”. For instance, memory 1404 of the computer system 1400 is illustrated as including executable component 1406. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computer system, whether such an executable component exists in the heap of a computer system, or whether the executable component exists on computer-readable storage media.

In such a case, one of ordinary skill in the art will recognize that the structure of the executable component exists on a computer-readable medium such that, when interpreted by one or more processors of a computer system (e.g., by a processor thread), the computer system is caused to perform a function. Such a structure may be computer-readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hardcoded or hard-wired logic gates, that are implemented exclusively or near-exclusively in hardware, such as within a field-programmable gate array (FPGA), an application-specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description above, embodiments are described with reference to acts that are performed by one or more computer systems. If such acts are implemented in software, one or more processors (of the associated computer system that performs the act) direct the operation of the computer system in response to having executed computer-executable instructions that constitute an executable component. For example, such computer-executable instructions may be embodied in one or more computer-readable media that form a computer program product. An example of such an operation involves the manipulation of data. If such acts are implemented exclusively or near-exclusively in hardware, such as within an FPGA or an ASIC, the computer-executable instructions may be hardcoded or hard-wired logic gates. The computer-executable instructions (and the manipulated data) may be stored in the memory 1404 of the computer system 1400. Computer system 1400 may also contain communication channels 1408 that allow the computer system 1400 to communicate with other computer systems over, for example, network 1410.

While not all computer systems require a user interface, in some embodiments, the computer system 1400 includes a user interface system 1412 for use in interfacing with a user. The user interface system 1412 may include output mechanisms 1412A as well as input mechanisms 1412B. The principles described herein are not limited to the precise output mechanisms 1412A or input mechanisms 1412B; as such will depend on the nature of the device. However, output mechanisms 1412A might include, for instance, speakers, displays, tactile output, holograms, and so forth. Examples of input mechanisms 1412B might include, for instance, microphones, touchscreens, holograms, cameras, keyboards, mouse or other pointer input, sensors of any type, and so forth.

Embodiments described herein may comprise or utilize a special purpose or general-purpose computer system, including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computer system.

A “network” is defined as one or more data links that enable the transport of electronic data between computer systems and/or modules and/or other electronic devices. When information is transferred or provided over a network or another communications connection (either hard-wired, wireless, or a combination of hard-wired or wireless) to a computer system, the computer system properly views the connection as a transmission medium. Transmissions media can include a network and/or data links that can be used to carry desired program code means in the form of computer-executable instructions or data structures and which can be accessed by a general-purpose or special-purpose computer system. Combinations of the above should also be included within the scope of computer-readable media.

Further, upon reaching various computer system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then eventually transferred to computer system RAM and/or to less volatile storage media at a computer system. Thus, it should be understood that storage media can be included in computer system components that also (or even primarily) utilize transmission media.

Computer-executable instructions comprise, for example, instructions and data which, when executed at a processor, cause a general-purpose computer system, special purpose computer system, or special purpose processing device to perform a certain function or group of functions. Alternatively or in addition, the computer-executable instructions may configure the computer system to perform a certain function or group of functions. The computer-executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, data centers, wearables (such as glasses) and the like. The invention may also be practiced in distributed system environments where local and remote computer systems, which are linked (either by hard-wired data links, wireless data links, or by a combination of hard-wired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

The various components or functional blocks may be implemented on a local computer system or may be implemented on a distributed computer system that includes elements resident in the cloud or that implement aspect of cloud computing. The various components or functional blocks may be implemented as software, hardware, or a combination of software and hardware. The computer systems of the remaining figures may include more or less than the components illustrated in the figures, and some of the components may be combined as circumstances warrant. Although not necessarily illustrated, the various components of the computer systems may access and/or utilize a processor and memory, such as processing unit 1402 and memory 1404, as needed to perform their various functions.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A smart computer pointing device for providing control signals to a computer system for controlling a graphical user interface displayed on a first display, the smart computer pointing device comprising:
a communication interface configured to communicate with the computer system;
a processor;
a hardware storage device configured to store executable instructions;
a body comprising:
a top surface having one or more touch-sensitive areas configured to detect one or more touch inputs; and
a bottom surface configured to rest on a flat surface; and
at least one of:
a motion sensor disposed at the bottom surface of the body configured to detect a motion of the body relative to the flat surface;
a wheel configured to rotate in response to a scrolling operation of a user;
a second display overlaid with at least one of the one or more touch-sensitive areas;
a speaker configured to play a sound;
a microphone configured to detect a sound; or
a biometric sensor configured to generate a biometric measurement of a user;
wherein when the executable instructions are executed by the processor, the processor is configured to convert (1) the one or more touch inputs detected by the one or more touch-sensitive areas, (2) the motion of the body detected by the motion sensor, (3) a rotation of the wheel, or (4) the biometric measurement generated by the biometric sensor to one or more control signals; and
transmit the one or more control signals to the computer system via the communication interface for controlling the graphical user interface.

2. The smart computer pointing device of claim 1, wherein the one or more touch-sensitive areas include a first touch-sensitive area on a left side of the top surface and a second touch-sensitive area on a right side of the top surface.

3. The smart computer pointing device of claim 2, wherein each of the first touch-sensitive area and the second touch-sensitive area is configured to receive at least a tap input, a swipe input, or a long press input.

4. The smart computer pointing device of claim 3, wherein the first touch-sensitive area and the second touch-sensitive area are configured to receive (1) a left swipe touch input, which starts in the first touch-sensitive area and ends in the second touch-sensitive area, or (2) a right swipe input, which starts in the second touch-sensitive area and ends in the second touch-sensitive area.

5. The smart computer pointing device of claim 1, wherein the smart computer pointing device includes a first wheel configured to rotate in a first direction and a second wheel configured to rotate in a second direction,
when the first wheel is rotated, the graphical user interface is caused to scroll in vertically, and
when the second wheel is rotated, the graphical user interface is caused to scroll horizontally.

6. The smart computer pointing device of claim 1, wherein the biometric sensor includes at least one of (1) a heart rate sensor, (2) a respiration rate sensor, (3) an oxygen-level sensor, (4) a blood pressure sensor, or (5) a thermometer configured to measure a vital sign of the user.

7. The smart computer pointing device of claim 1, wherein:
the biometric sensor includes a fingerprint sensor,
the body further includes a side surface that connects the top surface and the bottom surface, and
at least one of a wheel, a touch-sensitive area, or a fingerprint sensor is disposed on the side surface.

8. The smart computer pointing device of claim 1, wherein:
the biometric sensor includes at least one fingerprint sensor or a palmprint sensor;
the at least one fingerprint sensor or palmprint sensor is disposed on the top surface, and the processor is configured to transmit the fingerprint and the palmprint to the computer system, causing the computer system to authenticate the user.

9. The smart computer pointing device of claim 8, wherein the at least one fingerprint sensor or palmprint sensor is configured to detect a fingerprint or a palmprint of the user at a predetermined frequency.

10. The smart computer pointing device of claim 1, wherein the motion sensor comprises:
a light emitter configured to emit a light beam onto the surface, the surface reflecting the light beam;
a light receiver configured to receive the light beam reflected by the surface;
wherein the processor is configured to process the light beam reflected by the surface to detect a motion of the body of the smart computer pointing device relative to the surface.

11. The smart computer pointing device of claim 1, wherein the second display is overlaid with at least one touch-sensitive area and configured to display at least a portion of the graphical user interface displayed on a second display.

12. The smart computer pointing device of claim 11, wherein the processor, the speaker, the microphone, or the display are configured to function as a smart speaker or a smart display configured to receive a voice command and respond to the voice command with the speaker or the display.

13. The smart computer pointing device of claim 1, wherein a palmprint sensor is disposed on the top surface configured to detect the palmprint of the user.

14. The smart computer pointing device of claim 1, wherein the top surface is spherical dome-shaped.

15. The smart computer pointing device of claim 14, wherein the one or more touch-sensitive areas are symmetric about a diameter of the top surface, such that the smart computer pointing device can be placed in any orientation relative to the surface and the user.

16. The smart computer pointing device of claim 1, wherein at least one LED is overlaid under each of the one or more touch-sensitive areas,
in response to a touch input on a particular touch-sensitive area of the one or more touch-sensitive areas, the LED under the particular touch-sensitive area is caused to light up.

17. The smart computer pointing device of claim 16, wherein an array of LEDs is overlaid under at least one of the one or more touch-sensitive areas,
in response to a touch input, a subset of the LED near the touch input lights up.

18. A smart computer pointing device for providing control signals to a computer system for controlling a graphical user interface displayed on a first display, the smart computer pointing device comprising:
a communication interface configured to communicate with the computer system;
a processor;
a hardware storage device configured to store executable instructions;
a body comprising:
a top surface having a touch-sensitive area configured to detect one or more touch inputs; and
a bottom surface configured to rest on a flat surface; wherein:
when the executable instructions are executed by the processor, the processor is configured to divide the touch-sensitive area into a plurality of areas, each of the plurality of areas forming a virtual button or a virtual wheel;
in response to receiving a tap touch input in an area corresponding to the virtual button, the virtual button is configured to perform a click operation;
in response to receiving a swipe touch in an area corresponding to the virtual wheel, the virtual wheel is configured to perform a scroll operation; and
transmit the click operation or the scroll operation to the computer system via the communication interface for controlling the graphical user interface.

19. The smart computer pointing device of claim 18, wherein:
the touch-sensitive area is overlaid with a display to form a touch display; and
the touch display is configured to display the virtual button or the virtual wheel.

20. The smart computer pointing device of claim 19, wherein:
in response to receiving a tap touch input in the area corresponding to the virtual button, the touch display is configured to display a first sequence of moving images in an area of the virtual button to emulate a motion of clicking a mechanical button, or
in response to receiving a swipe touch input in the area corresponding to the virtual wheel, the touch display is configured to display a sequence of moving images in an area of the virtual wheel to emulate a motion of scrolling a mechanical wheel.
